(19) United States
(12) Patent Application Publication
(10) Pub. No.: US 2021/0370866 A1
(43) Pub. Date: Dec. 2, 2021

(54) VEHICLE CONTROL SYSTEM AND VEHICLE CONTROL METHOD

(71) Applicant: HONDA MOTOR CO., LTD., Tokyo (JP)

(72) Inventors: Ryo Morosawa, Tokyo (JP); Haisong Liu, Tokyo (JP); Akira Nakajima, Tokyo (JP); Kenji Okuma, Tokyo (JP); Hiroaki Maruyama, Tokyo (JP); Yoshikazu Matsuo, Tokyo (JP); Shuto Higashi, Tokyo (JP); Fumiaki Yamaguchi, Tokyo (JP)

(21) Appl. No.: 17/329,499

(22) Filed: May 25, 2021

(30) Foreign Application Priority Data
May 27, 2020 (JP) 2020-092520

(51) Int. Cl. B60R 25/01; B60R 25/30; B60R 25/31; E05F 15/73; G06K 9/00

(52) U.S. Cl. CPC B60R 25/01; B60R 25/305; B60R 25/31; E05F 15/73; G06K 9/00832; E05Y 2900/531; G06K 9/00791; E05F 2015/767; E05Y 2400/45; E05Y 2400/85; G06K 9/00335

(57) ABSTRACT

The present invention includes: a vehicle exterior image acquisition unit acquiring a vehicle exterior image being an image of an external surrounding of a vehicle; a vehicle interior image acquisition unit acquiring a vehicle interior image being an image of an interior of the vehicle; a person recognition unit recognizing, based on the vehicle exterior and interior images, respective motions of a person outside the vehicle and a person in the vehicle; and a door control unit controlling a state of a door of the vehicle, wherein, if a person outside the vehicle approaching the vehicle has been recognized based on a recognition result of the person recognition unit, if the person in the vehicle has performed an instruction motion indicating any seat of the vehicle, the door control unit executes an opening operation on the door corresponding to the seat indicated by the instruction motion.

### INCORPORATION BY REFERENCE

The present application claims priority under 35 U.S.C. § 119 to Japanese Patent Application No. 2020-092520 filed on May 27, 2020. The content of the application is incorporated herein by reference in its entirety.

### BACKGROUND OF THE INVENTION

### Field of the Invention

The present invention relates to motion control of onboard equipment, and particularly relates to a vehicle control system and a vehicle control method controlling the operation relating to opening and closing of vehicle doors.

### Description of the Related Art

Entry systems for vehicles that utilize image authentication are known in the conventional art (for example, see Japanese Patent Publication Laid-Open No. 2003-138817). In this entry system, an iris image of a person using the vehicle (vehicle user) is registered in advance, and upon detection of a person who approaches the vehicle and reaches for the doorknob, identification of the person is executed using the person's iris image. The entry system is configured to unlock the door if it has been confirmed that the person is the vehicle user. According to this system, the vehicle user whose iris image is stored in advance can unlock the door by simply approaching the vehicle and reaching for the doorknob, which relieves the burden on the vehicle user when boarding the vehicle.

However, scenarios in which unlocking and other automatic operation relating to opening of the doors is desirable may include not only a scenario in which the registered vehicle user him- or herself boards the vehicle, but also, for example, a scenario in which the vehicle user uses the vehicle to go to pick up another person and the other person boards the vehicle. In this case, a method for automatically unlocking the vehicle door when the other person approaches may include advance registration of information for determining whether or not the person approaching the vehicle is a person to be picked up, the information being registered in the vehicle in association with the vehicle user. However, registering every person who may board the vehicle (scheduled boarder) would make preparations for using the vehicle cumbersome and inconvenient.

In addition, in case the scheduled boarder is registered in advance as described above, the scheduled boarder approaching the vehicle may board through any door, which may lead to undesirable situations for the vehicle user in the vehicle. For example, in a case where an infant is in the vehicle with the vehicle user, the infant may be exposed to cold wind or rain if the scheduled boarder does not notice the infant and inadvertently opens the door of the seat where the infant is sitting. Alternatively, if the scheduled boarder has a lot of baggage or large baggage, then if the scheduled boarder gets in from the passenger seat door, the baggage may interfere with operation of the gear shift lever or the like, which is not desirable.

In addition, for example, in cases where there are several scheduled boarders, it is often desirable that seating of the scheduled boarders be performed under the supervision of the vehicle user, from the perspective of creating a good atmosphere in the vehicle or out of consideration for the scheduled boarders, due to the makeup of the scheduled boarders (men, women, children, adults, etc.), their relationships (family, acquaintances, friends thereof, etc.), or the state of the scheduled boarders (such has having a lot of baggage, having bad legs, etc.).

### SUMMARY OF THE INVENTION

### Problem to be Solved by the Invention

In view of this background, in vehicle control controlling operations related to opening and closing of vehicle doors, there is a demand for ensuring security of the vehicle while supporting smooth boarding by persons other than a registered vehicle user in such a way that seats can be assigned as desired by the vehicle user.

### Means for Solving the Problem

An aspect of the present invention is a vehicle control system including: a vehicle exterior image acquisition unit that acquires a vehicle exterior image, which is an image of an external surrounding of a vehicle; a vehicle interior image acquisition unit that acquires a vehicle interior image, which is an image of an interior of the vehicle; a person recognition unit that recognizes, based on the vehicle exterior image and the vehicle interior image, respective motions of a person outside the vehicle and a person in the vehicle; and a door control unit that controls a state of a door of the vehicle, wherein, if a person outside the vehicle approaching the vehicle has been recognized based on a recognition result of the person recognition unit, if the person in the vehicle has performed an instruction motion indicating any seat of the vehicle, the door control unit executes an opening operation on the door corresponding to the seat indicated by the instruction motion.

According to another aspect of the present invention, if the person in the vehicle has performed the instruction motion, the door control unit executes the opening operation on the door corresponding to the seat indicated by the instruction motion, on a condition that the person in the vehicle has directed his or her face or gaze toward the approaching person outside the vehicle.

According to another aspect of the present invention, if the person recognition unit has recognized a plurality of the approaching persons outside the vehicle, the door control unit displays facial images of the recognized plurality of persons outside the vehicle approaching the vehicle, and, according to the instruction motion by the person in the vehicle, executes the opening operation on the door corresponding to the seat indicated by the instruction motion, with a number of times equal to the number of the displayed plurality of approaching persons outside the vehicle as an upper limit.

According to another aspect of the present invention, the vehicle control system further includes a user identifying unit configured to identify, of the persons in the vehicle, a registered user who has been registered in advance as a user of the vehicle,

wherein, if the person in the vehicle has performed the instruction motion, the door control unit executes the opening operation on the door corresponding to the seat indicated by the instruction motion, on a condition that the person in the vehicle is a registered user.

According to another aspect of the present invention, the door control unit also executes the opening operation on the door corresponding to the seat indicated by the instruction motion in a case where an instruction motion by the person in the vehicle who is the registered user has been recognized, and then another person in the vehicle who is not the registered user has performed the instruction motion.

According to another aspect of the present invention, the door control unit executes the opening operation on the door corresponding to the seat indicated by the instruction motion if the seat is not occupied by another person in the vehicle.

According to another aspect of the present invention, the opening operation is an automatic operation of opening the door, or setting the door to be openable from outside the vehicle.

Another aspect of the present invention is a vehicle control method executed by a computer performing vehicle control, the method including the steps of: acquiring a vehicle exterior image, which is an image of an external surrounding of a vehicle; acquiring a vehicle interior image, which is an image of an interior of the vehicle; respectively recognizing, based on the vehicle exterior image and the vehicle interior image, motions of a person outside the vehicle and a person in the vehicle; and controlling a state of a door of the vehicle; wherein at the step of controlling, if a person outside the vehicle approaching the vehicle has been recognized based on a recognition result of the step of recognizing, if the person in the vehicle has performed an instruction motion indicating any seat of the vehicle, an opening operation is executed on the door corresponding to the seat indicated by the instruction motion.

### Effects of the Invention

According to an aspect of the present invention, it is possible to enable vehicle control for controlling an operation relating to opening and closing of the vehicle doors which ensures security of the vehicle while supporting smooth boarding by persons other than a registered vehicle user in such a way that seats can be assigned as desired by the vehicle user.

### BRIEF DESCRIPTION OF THE DRAWINGS

FIG. 1 shows an example of a scenario in which a vehicle equipped with a vehicle control system according to an embodiment of the present invention is used;

FIG. 2 shows a configuration of a vehicle control system according to an embodiment of the present invention; and

FIG. 3 is a flowchart exemplarily showing a procedure of an operation of the vehicle control system shown in FIG. 2.

### DETAILED DESCRIPTION OF THE PREFERRED EMBODIMENTS

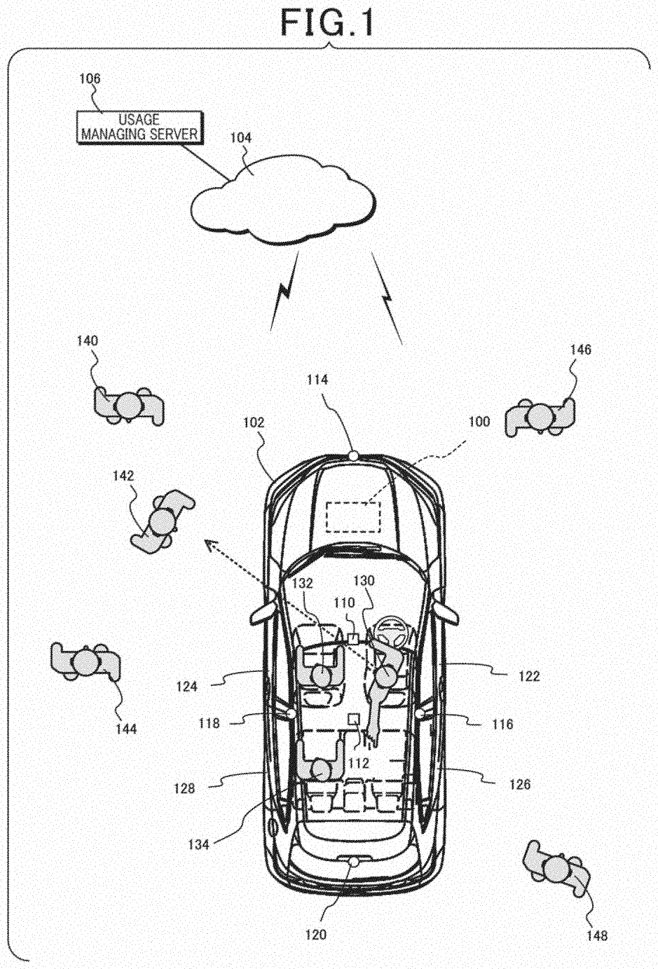

An embodiment of the present invention will be described below with reference to the drawings. FIG. 1 shows an example of a scenario in which a vehicle control system according to an embodiment of the present invention is used. The vehicle control system 100 according to the present embodiment is composed of, for example, a plurality of electronic control units (ECUs) installed in a vehicle 102, and controls an opening operation of the seat doors of the vehicle 102.

The vehicle control system 100 is communicably connected via a communication network 104 to a usage managing server 106 (computer) which is provided, for example, outside the vehicle 102. The communication network 104 may be, for example, an open network such as the Internet, or a private network. The usage managing server 106 stores information on users of the vehicle 102 registered in advance (registered users). This information may include, for example, a facial image, an identification (ID), and/or personal information (age, sex, mobile terminal information), etc. of a registered user.

The vehicle 102 includes a front seat camera 110 and a rear seat camera 112 which are internal cameras for capturing images of the vehicle interior. The front seat camera 110 is provided, for example, on the rear-view mirror, and captures images of the front half area of the interior of the vehicle 102. The rear seat camera 112 is provided, for example, on the inner surface of the ceiling of the vehicle interior, and captures images of the rear half area of the vehicle interior.

In addition, the vehicle 102 includes a front camera 114, a right side camera 116, a left side camera 118, and a rear camera 120, which are external cameras for capturing images of the vehicle's surroundings. The front camera 114 is provided, for example, on the front bumper, and captures images of the area in front of the vehicle 102 out of the surroundings. The right side camera 116 and the left side camera 118 are provided, for example, on the right-side pillar and left-side pillar of the vehicle 102, and respectively capture images of an area to the right and an area to the left of the vehicle 102 out of the surroundings. The rear camera 120 is provided, for example, on the rear bumper or the upper portion of the tailgate, and captures images of the area behind the vehicle 102 out of the surroundings.

The vehicle 102 may be used, for example, by each of a plurality of registered users who are registered in advance in the usage managing server 106 as users of the vehicle 102. The vehicle 102 may be, for example, a private vehicle or a carshare vehicle.

In the example shown in FIG. 1, the vehicle 102 includes four doors; driver seat door 122 and passenger seat door 124 which are front seat doors, and rear right seat door 126 and rear left seat door 128 which are rear seat doors. The vehicle control system 100 of the vehicle 102 controls an opening operation of the above four doors of the vehicle 102 based on actions of a person in the interior of the vehicle 102 (person in vehicle) and actions of a person outside the vehicle 102 (person outside vehicle).

Here, a door opening operation refers to an operation of setting the door in a state that allows a person outside the vehicle to board the vehicle 102, and may include, in addition to simply unlocking the door, an automatic operation of automatically opening the door using an actuator provided to the door. Further, for example, for door types in which the handle (door handle or doorknob) for opening and closing the door is stowed inside the door body, unlocking of the door lock as described above may include ejecting the door handle from the door body using an actuator to allow a person outside the vehicle to open the door.

In the scenario shown in FIG. 1, for example, a person 130 who is the current user and registered user of the vehicle 102 is in the vehicle 102 together with a person 132 and a person 134 who are unregistered users occupying the passenger seat and the rear left seat, and has come to pick up an acquaintance who is arriving at a station (not shown). The persons 132 and 134 who are unregistered users may be, for example, a child or family member, or a friend or acquaintance, etc. of the person 130 who is a registered user. Outside the vehicle 102, persons 140, 142, 144, 146, 148 who have emerged from the station are moving in their respective desired directions.

The person 142 outside the vehicle is the ones to be picked up by the persons 130, 132, 134 in the vehicle 102 are moving towards the vehicle 102.

In the above scenario, the vehicle control system 100 acquires vehicle exterior images, which are images of the external surroundings of the vehicle 102, using the front camera 114, right side camera 116, left side camera 118, and rear camera 120, which are external cameras. In addition, the vehicle control system 100 acquires vehicle interior images, which are images of the interior of the vehicle 102, using the front seat camera 110 and the rear seat camera 112, which are internal cameras. Here, the vehicle exterior images and vehicle interior images may be acquired as moving images (video), or as still images acquired repeatedly at predetermined time intervals.

Based on the acquired vehicle exterior image and vehicle interior image, the vehicle control system 100 recognizes motions of a person outside the vehicle and a person in the vehicle, as well as an occupancy status of the seats in the vehicle. If a person outside the vehicle approaching the vehicle 102 (approaching person) is recognized (or detected), then if a person in the vehicle 102 has performed as instruction motion indicating any seat in the vehicle 102, the vehicle control system 100 executes an opening operation on a door corresponding to the seat indicated by the instruction motion.

Here, the instruction motion may be a motion that people generally perform when pointing out a thing or place, or a specific motion determined in advance. In addition to a motion of pointing at a seat with the index finger, such as instruction motion may be, for example, a motion of raising the thumb and pointing over the shoulder at a rear seat, a motion of inclining the head to indicate the direction of a specific seat, a motion of using the head or chin to indicate the direction of a specific seat, etc.

In the scenario shown in FIG. 1, the vehicle control system 100 detects a person 142 as a person approaching the vehicle 102 (approaching person) from, for example, a vehicle exterior image acquired from the left side camera 118. In addition, based on a vehicle interior image, the vehicle control system 100 recognizes the motion of pointing at the rear right seat performed by the person 130 as an instruction motion indicating a seat. The vehicle control system 100 recognizes that the above instruction motion of the person 130, who is directing his or her gaze (shown by the dotted arrow in the drawing) at the person 142 who is an approaching person, is an instruction motion indicating the rear right seat, and executes the opening operation on the rear right seat door 126, which corresponds to the rear right seat.

In this way, by operating on the premise that a person is present in the vehicle, the vehicle control system 100 can ensure security of the vehicle while supporting smooth boarding by persons other than a vehicle user in such a way that seats can be assigned as desired by the vehicle user based on an instruction motion by the vehicle user.

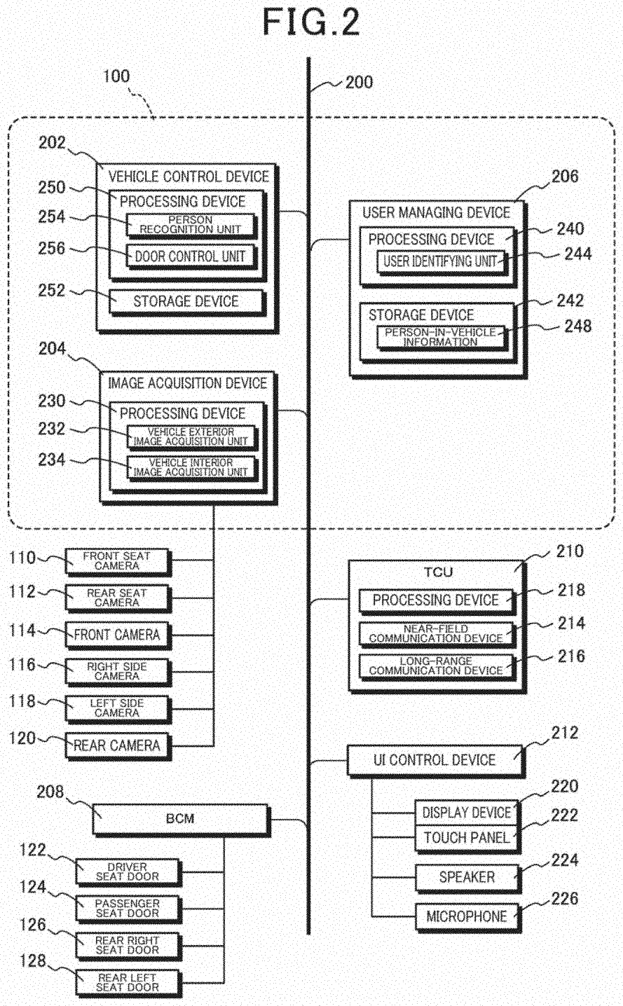

Next, with reference to FIG. 2, the configuration of the vehicle control system 100 will be described. In the present embodiment, the vehicle control system 100 is composed of a vehicle control device 202, an image acquisition device 204, and a user managing device 206, which are onboard electronic control units (ECUs).

The vehicle control device 202, the image acquisition device 204, and the user managing device 206 are communicably connected via an onboard network bus 200. Further connected to the onboard network bus 200 are a body control module (BCM) 208, a telematic control unit (TCU) 210, and a user interface (UI) control device 212.

The BCM 208 includes a processing device such as a CPU (not shown), and controls actuators provided to the driver seat door 122, the passenger seat door 124, the rear right seat door 126, and the rear left seat door 128 of the vehicle 102, in order to control an opening operation of these doors.

The TCU 210 includes a near-field communication device 214 (transmitter/receiver, circuit), a long-range communication device 216 (transmitter/receiver, circuit), and a processing device 218 that controls operations of these communication devices. The processing device 218 is, for example, a computer having a processor such as a CPU. The near-field communication device 214 is, for example, a wireless communication device that communicates with the mobile terminal (smartphone, computer) etc. according to the Bluetooth® communication standard. The long-range communication device 216 is a wireless communication device for communicating with, for example, the usage managing server 106 and the mobile terminal, etc. via the communication network 104.

The UI control device 212 includes a processing device such as a CPU (not shown), displays images on a display device 220 (display) provided to the interior of the vehicle 102 based on instructions from other devices of the vehicle 102 such as the vehicle control device 202, and outputs audio from a speaker 224. The UI control device 212 also acquires audio from the vehicle interior from a microphone 226, performs audio recognition processing on the audio, and outputs the audio and/or the result of the audio recognition processing to the other devices. The UI control device 212 also acquires instructions and/or data input from an occupant of the vehicle 102 via a touch panel 222 provided on a display screen of the display device 220, and outputs the acquired instructions and/or data to the other devices.

The image acquisition device 204 constituting the vehicle control system 100 includes a processing device 230 which is a computer including a processor such as a CPU, and includes as functional elements or functional units a vehicle exterior image acquisition unit 232 and a vehicle interior image acquisition unit 234. These functional elements are realized, for example, by the processing device 230, which is a computer, executing a program. This computer program may be stored on any computer-readable storage medium. As an alternative, part or all of the above functional elements of the processing device 230 may be constituted by hardware including respectively one or more electronic circuit components.

The vehicle exterior image acquisition unit 232 controls the front camera 114, the right side camera 116, the left side camera 118, and the rear camera 120, and acquires vehicle exterior images, which are images of the external surroundings of the vehicle 102, from these external cameras. In addition, the vehicle interior image acquisition unit 234 controls the front seat camera 110 and the rear seat camera 112, and acquires vehicle interior images, which are images of the interior of the vehicle 102, from these internal cameras. The vehicle exterior images and the vehicle interior images may be still images captured repeatedly at predetermined time intervals, or a video with a predetermined framerate. The image acquisition device 204 outputs the acquired vehicle exterior images and vehicle interior images to the other devices via the onboard network bus 200.

The user managing device 206 constituting the vehicle control system 100 specifies whether or not a person in the vehicle is a registered user who has been registered in advance as a user of the vehicle 102.

Specifically, the user managing device 206 includes a processing device 240 and a storage device 242. The storage device 242 is composed of, for example, a volatile and/or non-volatile semiconductor memory, and/or a hard disk device, etc. The processing device 240 is, for example, a computer having a processor such as a CPU. The processing device 240 includes as functional elements or functional units a user identifying unit 244.

The above functional elements of the processing device 240 are realized, for example, by the processing device 240, which is a computer, executing a program. This computer program may be stored on any computer-readable storage medium. As an alternative, part or all of the above functional elements of the processing device 240 may be constituted by hardware including respectively one or more electronic circuit components.

The user identifying unit 244 receives a vehicle interior image from the image acquisition device 204, and, based on the received vehicle interior image, performs facial image authentication on each person in the vehicle 102 to identify whether or not the person in the vehicle is a registered user. Specifically, the user identifying unit 244 acquires from the usage managing server 106 a facial image of each registered user already registered in the usage managing server 106 and compares them to the facial image of the person in the vehicle in the vehicle interior image to determine whether or not each person in the vehicle is a registered user.

The user identifying unit 244 stores, in the storage device 242, person-in-vehicle information 248 composed of, for example, a facial image of each person in the vehicle and identification information indicating whether each person in the vehicle is a registered user or an unregistered user. The identification information may include, for example, an identification (ID) etc. assigned in advance to each registered user. In this way, of the persons in the vehicle 102, a person in the vehicle whose identification information including the ID is stored in association with the facial image in the person-in-vehicle information 248 can be determined to be a registered user.

The user identifying unit 244 also identifies a person in the vehicle occupying the driver seat when use of the vehicle 102 is started as the current user of the vehicle 102, and, in the person-in-vehicle information 248, adds information to the identification information stored in association with the facial image of the current user to indicate that the person in the facial image is the current user. In addition to the above, the user identifying unit 244 may be configured to add to the person-in-vehicle information 248, for each unregistered user, information such as sex, age, etc. of the unregistered user estimated based on a facial image thereof.

In the present embodiment, the user identifying unit 244 identifies the person 130 occupying the driver seat of the vehicle 102 as a registered user and the current user, and identifies the persons 132, 134 as an unregistered user. Then, the user identifying unit 244 stores person-in-vehicle information 248 regarding the persons 130, 132 and the person 134 in the storage device 242.

The vehicle control device 202 constituting the vehicle control system 100 instructs the BCM 208 to control an opening operation of the vehicle doors based on the vehicle exterior image and vehicle interior image received from the image acquisition device 204, as well as the person-in-vehicle information acquired from the user managing device 206.

Specifically, the vehicle control device 202 includes a processing device 250 and a storage device 252. The storage device 252 is composed of, for example, a volatile and/or non-volatile semiconductor memory and/or a hard disk device. The processing device 250 is, for example, a computer having a processor such as a CPU. The processing device 250 includes as functional elements or functional units a person recognition unit 254 and a door control unit 256.

These functional elements of the processing device 250 are realized, for example, by the processing device 250, which is a computer, executing a program. This computer program may be stored on any computer-readable storage medium. As an alternative, part or all of the above functional elements of the processing device 250 may be constituted by hardware including respectively one or more electronic circuit components.

The person recognition unit 254 recognizes a motion of a person outside the vehicle and a motion of a person in the vehicle based on a vehicle exterior image and a vehicle interior image received from the image acquisition device 204. Specifically, the person recognition unit 254 recognizes a person outside the vehicle approaching the vehicle 102 (hereinafter also referred to as an approaching person). In addition, the person recognition unit 254 determines whether or not the person in the vehicle is performing a specific motion determined in advance with respect to the approaching person outside the vehicle. Here, the specific motion may be, for example, directing the face or gaze at the subject person for a predetermined time. In addition, the specific motion may be looking at the subject person, making a specific facial expression toward the subject person, and/or making a specific gesture toward the subject person, etc.

In addition, based on the vehicle interior image, the person recognition unit 254 recognizes whether or not any person in the vehicle 102 has performed an instruction motion indicating any seat in the vehicle 102. In addition, if the person recognition unit 254 has recognized an instruction motion, the person recognition unit 254 recognizes which seat the instruction motion indicates.

Further, based on the vehicle interior image, the person recognition unit 254 recognizes an occupancy status of the seats of the vehicle 102. That is to say, the person recognition unit 254 recognizes which seats in the interior of the vehicle 102 are free, and which seats are occupied (in which a person is sitting, or baggage is placed).

If a person outside the vehicle approaching the vehicle 102 (approaching person) has been recognized based on a recognition result of the person recognition unit 254, then if a person in the vehicle has performed an instruction motion indicating any seat of the vehicle 102, the door control unit 256 executes the opening operation on a door corresponding to the seat indicated by the instruction motion.

For example, in the scenario shown in FIG. 1, the person recognition unit 254 detects the person 142 as a person outside the vehicle approaching the vehicle 102. In addition, the person recognition unit 254 recognizes that the person 130 is performing an instruction motion (a finger pointing motion in the example of the drawing) indicating the rear right seat of the vehicle 102. Based on the recognition result of the person recognition unit 254, the door control unit 256 instructs the BCM 208 to execute the opening operation on the rear right seat door 126 corresponding to the rear right seat indicated by the instruction motion of the person 130.

In the above scenario, when an approaching person has been detected, the door control unit 256 may execute the opening operation on a door of a seat indicated by an instruction motion performed by any person in the vehicle. For example, in the scenario of FIG. 1, the door control unit 256 may be configured to execute the opening operation of the vehicle 102 based on the instruction motion even when the instruction motion has been performed by the person 132 in the passenger seat instead of the person 130 in the driver seat.

In addition to the above, the door control unit 256 may further execute the door opening operation based on an instruction motion when a person in the vehicle has performed the instruction motion, on the condition that the person in the vehicle is a registered user. For example, in the scenario shown in FIG. 1, if the person recognition unit 254 has recognized the person 142 as an approaching person and has recognized an instruction motion of the person 130 in the vehicle, the door control unit 256 inquires with the user managing device 206 to reference the person-in-vehicle information 248, thereby learning that the person 130 is a registered user. In this way, the door control unit 256 may execute the opening operation on the rear right seat door 126 of the vehicle 102 based on the instruction motion of the person 130, who is a registered user.

Alternatively, if an instruction motion by a person in the vehicle who is a registered user has been recognized, and another person in the vehicle who is not a registered user has then performed the instruction motion, the door control unit 256 may execute the opening operation on a door corresponding to the seat indicated by the instruction motion of the person in the vehicle who is not a registered user. For example, in the scenario shown in FIG. 1, if the person 130 who is a registered user mistakenly performs an instruction motion indicating the rear left seat occupied by the person 134, and the person recognition unit 254 recognizes this, and the person recognition unit 254 then recognizes that the person 132 who is an unregistered user has performed an instruction motion indicating the rear right seat, the door control unit 256 executes the opening operation on the rear right seat door 126.

In addition, if the person recognition unit 254 has recognized a plurality of approaching persons outside the vehicle, the door control unit 256 displays facial images of the recognized plurality of approaching persons outside the vehicle on, for example, the display device 220 via the UI control device 212. Then, with a number of times equal to the number of the displayed plurality of approaching persons outside the vehicle as an upper limit, the door control unit 256, in response to an instruction motion by a person in the vehicle, executes the opening operation on a door corresponding to the seat indicated by the instruction motion.

For example, in the scenario shown in FIG. 1, if the person recognition unit 254 has recognized the persons 140, 142 as approaching persons based on the vehicle exterior image, the door control unit 256 displays facial images of the persons 140, 142 on the display device 220 via the UI control device 212. Then, with a number of times equal to the number of approaching persons, that is to say two times as the upper limit, the door control unit 256, in response to each instruction motion by the person 130 (or persons 132, 134) in the vehicle, executes the opening operation on a door corresponding to the seat indicated by the instruction motion.

For example, if the person 134 has moved to the rear center seat, the door control unit 256, in response to two instruction motions, i.e. an instruction motion indicating the rear left seat and an instruction motion indicating the rear right seat, executes the opening operation respectively on the rear left seat door 128 and the rear right seat door 126. In this case, as described above, the opening operation of the doors may be performed in response to an instruction motion by any of the persons 130, 132, or 134 in the vehicle, or performed only in response to two instruction motions by the person 130 who is a registered user. Alternatively, with respect to each of two instruction motions by the person 130 who is a registered user, the door opening operation may be executed in response to an instruction motion performed by the person 132 or 134 who is an unregistered user after these instruction motions.

If a person outside the vehicle approaching the vehicle 102 has been detected, the vehicle control system 100 having the above configuration executes the opening operation on a door corresponding to a seat indicated by an instruction motion if it has been detected that a person in the vehicle has performed the instruction motion indicating any seat of the vehicle 102. This allows the vehicle control system 100 to ensure security of the vehicle by operating on the premise that a person is present in the vehicle, while supporting smooth boarding by persons other than a vehicle user in such a way that seats can be assigned as desired by the vehicle user according to an instruction motion by the vehicle user.

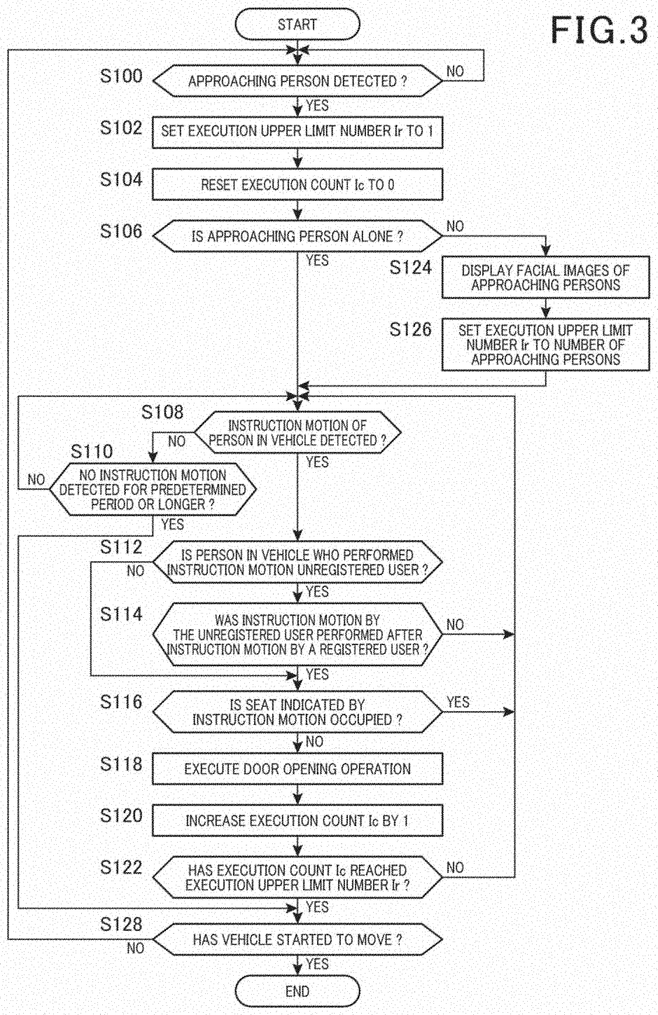

Next, an operation of the vehicle control system 100 will be described. FIG. 3 is a flowchart showing a procedure of a process of the vehicle control system 100. This process starts when the vehicle 102 is stopped or parked, for example, when the vehicle speed is less than a predetermined speed (for example, 5 km/h). The devices constituting the vehicle control system 100 may acquire information regarding the vehicle speed of the vehicle 102 via the BCM 208 connected, for example, to a vehicle speed sensor (not shown).

Moreover, in parallel to the process shown in FIG. 3, the image acquisition device 204 is configured to acquire, at respective specific time intervals, vehicle interior images from the front seat camera 110 and rear seat camera 112, and vehicle exterior images from the front camera 114, right side camera 116, left side camera 118, and rear camera 120. In addition, in parallel to the process shown in FIG. 3, the user managing device 206 is configured to recognize persons boarding and exiting the vehicle 102 and store person-in-vehicle information 248 in the storage device 242 during a period from, for example when a specific operation indicating start of use of the vehicle 102 has been performed until a specific operation indicating end of use of the vehicle 102 has been performed.

Here, the above specific operation indicating start of use and specific operation indicating end of use may respectively be an “on” operation and an “off” operation of the ignition key of the vehicle 102, performed, for example, by the current user. The user managing device 206 may be configured to acquire an indication that an “on” operation or “off” operation has been performed with respect to the ignition key from the BCM 208 connected to, for example, an ignition key sensor (not shown).

When the process shown in FIG. 3 is started, the person recognition unit 254 of the vehicle control device 202 constituting the vehicle control system 100 starts a recognition process of a person outside the vehicle and a person in the vehicle based on vehicle exterior images and vehicle interior images acquired from the image acquisition device 204, to determine whether or not a person outside the vehicle approaching the vehicle 102 (approaching person) has been detected (S100). If no approaching person has been detected (S100, NO), the person recognition unit 254 returns to step S100 and waits for an approaching person to be detected.

On the other hand, when the person recognition unit 254 has detected an approaching person (S100, YES), the door control unit 256 sets an execution upper limit number Ir to 1 (S102), and then resets an execution count Ic to 0 (zero) (S104). Next, based on a recognition result of the person recognition unit 254, the door control unit 256 determines whether or not the person approaching the vehicle 102 (approaching person) is alone (S106).

If the approaching person is alone (S106, YES), the door control unit 256 determines whether or not an instruction motion by a person in the vehicle, that is to say a motion indicating any seat of the vehicle 102, has been detected (S108). If no instruction motion has been detected (S108, NO), the door control unit 256 determines whether or not no instruction motion has been detected for a predetermined period since detection of the approaching person at step S100, or for a predetermined period since the last detection of an instruction motion (S110).

If no instruction motion has been detected for a predetermined period (S110, YES), the door control unit 256 moves the process to step S128 described below. On the other hand, if this is not the case, that is to say if no time has yet passed since the detection of the approaching person at step S100 or a predetermined time has not yet passed since the last detection of an instruction motion (S110, NO), the door control unit 256 returns to step S108 and repeats the process.

On the other hand, if an instruction motion of a person in the vehicle has been detected at step S108 (S108, YES), the door control unit 256 references the person-in-vehicle information 248 in the storage device 242 via the user managing device 206 to determine whether or not the person in the vehicle who performed the instruction motion is an unregistered user (S112). If the person in the vehicle who performed the instruction motion is an unregistered user (S112, YES), the door control unit 256 determines whether or not the instruction motion of the unregistered user was performed after an instruction motion of a registered user (S114).

If the instruction motion of the unregistered user was not performed after an instruction motion of a registered user (S114, NO), the door control unit 256 returns to step S108 and repeats the process. On the other hand, if the instruction motion of the unregistered user was performed after an instruction motion of a registered user (S114, YES), the door control unit 256 determines whether or not the seat indicated by the instruction motion is occupied, for example, by a person or baggage, etc. (S116).

If the seat indicated by the instruction motion is occupied (S116, YES), the door control unit 256 returns to step S108 and repeats the process. On the other hand, if the seat indicated by the instruction motion is not occupied (S116, NO), the door control unit 256 executes the opening operation on the door corresponding to the seat (S118). Here, the door control unit 256 may execute the door opening operation on the condition that the person in the vehicle who performed the instruction motion has directed his or her gaze or face toward the approaching person over a predetermined period. In this case, if the person in the vehicle who performed the instruction motion has not directed his or her gaze or face toward the approaching person over the predetermined period, the door control unit 256 may return to step S108 and repeat the process.

Next, the door control unit 256 adds 1 to the execution count Ic (S120), and then determines whether or not the execution count Ic has reached the execution upper limit number Ir (S122). If the execution count Ic has reached the execution upper limit number Ir (S122, YES), the door control unit 256 determines whether or not the vehicle 102 has finished stopping or parking and has started to move (S128). The door control unit 256 may determine that the vehicle 102 has started to move when, for example, the vehicle speed of the vehicle 102 is equal to or greater than a predetermined speed (for example, 5 km/h). As described above, the door control unit 256 may be configured to acquire information regarding the vehicle speed of the vehicle 102 via, for example, the BCM 208. If the vehicle 102 has not started to move (S128, NO), the door control unit 256 returns to step S100 and waits for an approaching person to be newly detected. On the other hand, if the execution count Ic has not reached the execution upper limit number Ir at step S122 (S122, NO), the door control unit 256 returns to step S108 and waits for a person in the vehicle to newly perform an instruction motion within the predetermined period.

On the other hand, if the person in the vehicle who performed the instruction motion is found not to be an unregistered user at step S112, that is to say, if the person in the vehicle is a registered user (S112, NO), the door control unit 256 moves the process to step S116.

Alternatively, if the approaching person is not alone at step S106, that is to say if there are a plurality of approaching persons (S106, NO), the door control unit 256 instructs, for example, the UI control device 212 to display facial images of the approaching persons on the display device 220 (S124). Next, the door control unit 256 sets the execution upper limit number Ir to the number of approaching persons (S126), and then moves the process to step S108.

It should be noted that the present invention is not limited to the configuration of the embodiment described above, and that it may be implemented in various forms within a scope that does not depart from the gist of the invention.

For example, in the present embodiment, a vehicle 102 having for seat doors is described as an example, but the configuration of the vehicle 102 in which the vehicle control system 100 is installed is not so limited. The vehicle 102 may be a vehicle having any number of seat doors equal to or greater than two. For example, the vehicle 102 may have six or eight seat doors.

In addition, in the present embodiment, one registered user (person 130) who is the current user and two unregistered users (persons 132 and 134) are in the vehicle 102, but the makeup of occupants of the vehicle 102 is not so limited. It is sufficient that one or more registered users are in the vehicle 102. For example, a plurality of registered users may be in the vehicle 102. In addition, there may be no unregistered users in the vehicle 102, or any number of unregistered users.

Here, the door control unit 256 may be configured to execute the door opening operation based on an instruction motion of any person in the vehicle who is a registered user, or based on an instruction motion of any person in the vehicle who is an unregistered user on the premise that an instruction motion of a person in the vehicle who is any registered user has been performed. In this case, if the instruction motions differ between a plurality of registered users or a plurality of unregistered users, the door opening operation may be performed based on an instruction motion with the highest priority according to a predetermined priority order. The priority order may be, for example, an order of ages of the persons who performed the instruction motions, or an order of the timing (where the last instruction motion has top priority, etc.).

Alternatively, the door control unit 256 may be configured to perform the opening operation on a door of a seat indicated by an instruction motion by any person in the vehicle, regardless of whether the person is a registered user or an unregistered user. Since an instruction motion by a person in the vehicle who is an unregistered user may be immediately corrected by a registered user in the same vehicle in some form (such as a vocal instruction to the person in the vehicle or person outside the vehicle) if such correction is necessary, the configuration described above can also ensure security of the vehicle 102 due to the presence of persons in the vehicle 102, while supporting smooth boarding by persons outside the vehicle in such a way that seats can be assigned as desired by the person in the vehicle who is the registered user.

However, as the embodiment described above, having a door opening operation based on an instruction motion of a person in the vehicle who is a registered user be a main operation, and a door opening operation based on an instruction motion of a person in the vehicle who is an unregistered user be an auxiliary operation on the condition that an instruction motion has been performed by a person in the vehicle who is a registered user, makes it possible to more directly realize a seating assignment desired by the person in the vehicle who is a registered user.

In addition, in the present embodiment, when there are a plurality of approaching persons, the door control unit 256 of the vehicle control device 202 may set the number of approaching persons as the execution upper limit number Ir and execute the door opening operation (for example, several times) according to instruction motions by persons in the vehicle, but the operation of the door control unit 256 is not so limited. For example, the door control unit 256 may be configured to, after displaying facial images of the plurality of approaching persons on the display device 220, receive a selection of facial images by a registered user in the vehicle via the touch panel 222 or the like, set the number of facial images selected by the registered user as the execution upper limit number Ir, and execute the door opening operation. This makes it possible to correctly limit the execution upper limit number Ir to a number of approaching persons who are acquaintances, etc. of the registered user, and prevent an unnecessary door opening operation from being executed.

In addition, the door control unit 256 may change the door opening operation according to the situation outside the vehicle. For example, the door control unit 256 may be configured to perform automatic opening as the door opening operation if there is only one approaching person outside the vehicle, and simply unlock the door or provide a doorknob (eject the doorknob from the door body) as the door opening operation if there are several approaching persons. Thus, in a case where a plurality of approaching persons are present, this makes it possible to reduce the likelihood of unauthorized boarding by an approaching person whom the person in the vehicle does not intend to allow to board the vehicle.

In addition, in the present embodiment, the vehicle control system 100 is composed of a plurality of devices (the vehicle control device 202, the image acquisition device 204, and the user managing device 206), but the configuration of the vehicle control system 100 is not so limited. The vehicle control system 100 may be composed of fewer or more devices than this. One or several of such devices may be provided to the usage managing server 106 and/or another server which is provided outside the vehicle 102 and is communicably connected to the onboard devices. Alternatively, the vehicle control system 100 may be configured as one device in the vehicle 102.

As described above, the vehicle control system 100 according to the present embodiment includes a vehicle exterior image acquisition unit 232 which acquires a vehicle internal image which is an image of the external surroundings of the vehicle 102, and a vehicle interior image acquisition unit 234 which acquires a vehicle interior image which is an image of the interior of the vehicle 102. In addition, the vehicle control system 100 includes a person recognition unit 254 which respectively recognizes motions of a person outside the vehicle and a person inside the vehicle interior based on the vehicle exterior image and the vehicle interior image, and a door control unit 256 which controls a state of a door of the vehicle 102. If a person outside the vehicle approaching the vehicle 102 (approaching person) has been recognized based on the recognition result of the person recognition unit 254, then when a person in the vehicle has performed an instruction motion indicating any seat of the vehicle 102, the door control unit 256 executes the opening operation on a door corresponding to the seat indicated by the instruction motion.

This configuration ensures security of the vehicle while supporting smooth boarding by persons other than a registered vehicle user (registered user) in such a way that seats can be assigned as desired by the vehicle user.

In addition, in the vehicle control system 100, the door control unit 256 executes the opening operation on a door corresponding to a seat indicated by an instruction motion when a person in the vehicle has performed the instruction motion, on the condition that the person in the vehicle has directed his or her face or gaze toward the approaching person over a predetermined period. In general, a person in a vehicle will not direct his or her gaze or face toward an approaching person if the person in the vehicle does not intend to let the approaching person board the vehicle. Therefore, since the door opening operation is not performed with respect to approaching persons that the person in the vehicle does not intend to let board the vehicle according to this configuration, security of the door opening operation can be further improved.

In addition, in the vehicle control system 100, if the person recognition unit 254 has recognized a plurality of approaching persons, the door control unit 256 displays facial images of the plurality of approaching persons. The door control unit 256, according to an instruction motion by a person in the vehicle, executes the opening operation on a door corresponding to the seat indicated by the instruction motion, with a number of times equal to the number of the displayed plurality of approaching persons as the upper limit.

According to this configuration, the opening operation can be performed on a plurality of doors when there are a plurality of approaching persons, which supports smooth boarding by the plurality of approaching persons.

In addition, the vehicle control system 100 includes a user identifying unit 244 which determines whether or not the person in the vehicle 102 is a registered user who has been registered in advance as a user of the vehicle 102. If a person in the vehicle has performed an instruction motion, the door control unit 256 executes the opening operation on a door corresponding to the seat indicated by the instruction motion on the condition that the person in the vehicle is a registered user.

According to this configuration, the door opening operation can be prevented from being performed inadvertently by, for example, a child who is an unregistered user waving at a stranger approaching the vehicle 102.

In addition, in the vehicle control system 100, if an instruction motion by a person in the vehicle who is a registered user has been recognized, and another person in the vehicle who is not a registered user has performed an instruction motion, the door control unit 256 executes the opening operation on a door corresponding to the seat indicated by the instruction motion. According to this configuration, the door opening operation is performed even with respect to an instruction motion by an unregistered user on the premise that a registered user has performed an instruction motion, which ensures security while supporting smooth execution of the door opening operation. For example, according to this configuration, in a case where a registered user has mistakenly performed an instruction motion indicating a seat occupied by another person, an unregistered user may correct this and instruct the opening operation on a door of an unoccupied seat.

In addition, in the vehicle control system 100, if the seat indicated by the instruction motion is not occupied by another person in the vehicle, the door control unit 256 executes the opening operation on a door corresponding to the seat. This configuration makes it possible to prevent the door of an occupied seat from being opened.

In addition, in the vehicle control system 100, the door opening operation done by the door control unit 256 is an automatic operation of opening the doors, or setting the doors to be openable from outside the vehicle 102. According to this configuration, the door control unit 256 is able to support smooth boarding by approaching persons outside the vehicle not only by automatically opening the doors, but by various operations such as unlocking the doors, ejecting a doorknob stowed in the door to be in an operable state, etc.

In addition, by means of a computer that performs vehicle control, the vehicle control system 100 executes a vehicle control method that performs the following process. The vehicle control method includes a step of acquiring a vehicle exterior image, which is an image of the external surroundings of the vehicle 102, a step of acquiring a vehicle interior image, which is an image of the interior of the vehicle 102, a step of respectively recognizing, based on the vehicle exterior image and the vehicle interior image, motions of a person outside the vehicle and a person in the interior of the vehicle, and a step of controlling the state of the doors of the vehicle 102. If a person outside the vehicle approaching the vehicle 102 (approaching person) has been recognized based on the recognition result of the step of recognizing, then, at the above step of controlling, if a person in the vehicle has performed an instruction motion indicating any seat of the vehicle 102, the opening operation is executed on a door corresponding to the seat indicated by the instruction motion.

This configuration ensures security of the vehicle while supporting smooth boarding by persons other than a registered vehicle user (registered user) in such a way that seats can be assigned as desired by the vehicle user.

### REFERENCE SIGNS LIST

100 Vehicle control system
102 Vehicle
104 Communication network
106 Usage managing server
110 Front seat camera
112 Rear seat camera
114 Front camera
116 Right side camera
118 Left side camera
120 Rear camera
122 Driver seat door
124 Passenger seat door
126 Rear right seat door
128 Rear left seat door
130, 132, 140, 142, 144, 146, 148 Person
200 Onboard network bus
202 Vehicle control device
204 Image acquisition device
206 User managing device
208 BCM
210 TCU
212 UI control device
214 Near-field communication device
216 Long-range communication device
218 Processing device
220 Display device
222 Touch panel
224 Speaker
226 Microphone
230, 240, 250 Processing device
232 Vehicle exterior image acquisition unit
234 Vehicle interior image acquisition unit
242, 252 Storage device
244 User identifying unit
248 Person-in-vehicle information
254 Person recognition unit
256 Door control unit

What is claimed is:

1. A vehicle control system comprising:
a vehicle exterior image acquisition unit configured to acquire a vehicle exterior image, which is an image of an external surrounding of a vehicle;
a vehicle interior image acquisition unit configured to acquire a vehicle interior image, which is an image of an interior of the vehicle;
a person recognition unit configured to recognize, based on the vehicle exterior image and the vehicle interior image, respective motions of a person outside the vehicle and a person in the vehicle; and
a door control unit configured to control a state of a door of the vehicle,
wherein, if a person outside the vehicle approaching the vehicle has been recognized based on a recognition result of the person recognition unit, if the person in the vehicle has performed an instruction motion indicating any seat of the vehicle, the door control unit executes an opening operation on the door corresponding to the seat indicated by the instruction motion.

2. The vehicle control system according to claim 1, wherein if the person in the vehicle has performed the instruction motion, the door control unit executes the opening operation on the door corresponding to the seat indicated by the instruction motion, on a condition that the person in the vehicle has directed his or her face or gaze toward the approaching person outside the vehicle.

3. The vehicle control system according to claim 1, wherein if the person recognition unit has recognized a plurality of the approaching persons outside the vehicle, the door control unit displays facial images of the recognized plurality of persons outside the vehicle approaching the vehicle, and, according to the instruction motion by the person in the vehicle, executes the opening operation on the door corresponding to the seat indicated by the instruction motion, with a number of times equal to the number of the displayed plurality of approaching persons outside the vehicle as an upper limit.

4. The vehicle control system according to claim 1, further comprising a user identifying unit configured to identify, of the persons in the vehicle, a registered user who has been registered in advance as a user of the vehicle,
wherein, if the person in the vehicle has performed the instruction motion, the door control unit executes the opening operation on the door corresponding to the seat indicated by the instruction motion, on a condition that the person in the vehicle is a registered user.

5. The vehicle control system according to claim 4, wherein the door control unit also executes the opening operation on the door corresponding to the seat indicated by the instruction motion in a case where an instruction motion by the person in the vehicle who is the registered user has been recognized, and then another person in the vehicle who is not the registered user has performed the instruction motion.

6. The vehicle control system according to claim 1, wherein the door control unit executes the opening operation on the door corresponding to the seat indicated by the instruction motion if the seat is not occupied by another person in the vehicle.

7. The vehicle control system according to claim 1, wherein the opening operation is an automatic operation of opening the door, or an operation of setting the door to be openable from outside the vehicle.

8. A vehicle control method executed by a computer performing vehicle control, the method comprising the steps of:
acquiring a vehicle exterior image, which is an image of an external surrounding of a vehicle;
acquiring a vehicle interior image, which is an image of an interior of the vehicle;
respectively recognizing, based on the vehicle exterior image and the vehicle interior image, motions of a person outside the vehicle and a person in the vehicle; and
controlling a state of a door of the vehicle;
wherein at the step of controlling, if a person outside the vehicle approaching the vehicle has been recognized based on a recognition result of the step of recognizing, if the person in the vehicle has performed an instruction motion indicating any seat of the vehicle, an opening operation is executed on the door corresponding to the seat indicated by the instruction motion.
